(19) United States
(12) Patent Application Publication
(10) Pub. No.: US 2008/0311826 A1
(43) Pub. Date: Dec. 18, 2008

(54) Griding and/or Polishing Tool, and Use and Manufacturing Thereof

(75) Inventor: Hakan Thysell, Soderkoping (SE)

Correspondence Address: MERCHANT & GOULD PC, P.O. BOX 2903, MINNEAPOLIS, MN, 55402-0903, US

(73) Assignee: HTC Sweden AB, Soderkoping (SE)

(21) Appl. No.: 12/066,030

(22) PCT Filed: Sep. 6, 2006
(86) PCT No.: PCT/SE2006/001024

§ 371 Date: Jul. 10, 2008

(30) Foreign Application Priority Data
Sep. 8, 2005 (SE) 0501992-2

(51) Int. Cl. B24B 1/00; B23F 21/03; B24D 3/00

(52) U.S. Cl. 451/41; 451/548; 51/295

(57) ABSTRACT

A grinding and/or polishing tool comprises a thin, substantially flat substrate, which has a grinding side to which grinding particles are applied, the substrate being substantially incompressible in a direction perpendicular to the grinding side, the grinding particles comprising diamond particles, and the grinding particles being fixed to the substrate by a curing plastic resin. Moreover, a grinding and/or polishing method is disclosed, in which such a grinding and/or polishing tool is used, and also a method of manufacturing such a grinding and/or polishing tool.

### FIELD OF THE INVENTION

The present invention relates to a grinding and/or polishing tool, its use and a method of manufacturing such grinding or polishing tools.

### BACKGROUND ART

Sandpaper which is used for grinding and/or polishing of wood consists of strong paper with a sand layer glued thereto, intended for grinding or polishing.

A drawback of such sandpaper is that the relatively weak adhesion caused by the glue results in the grains of sand, in use of the sandpaper, coming loose, thereby quickly ruining the sandpaper and necessitating exchange thereof.

It is known to manufacture what is referred to as “diamond sandpaper” by fixing grinding particles containing diamonds to a woven substrate by electroplating.

Such “diamond sandpaper” is, however, expensive to manufacture and has a relatively short life due to the weak adhesion. The weak adhesion also limits the size of the grinding particles since a large particle will be subjected to greater force when engaging the surface to be ground. The field of application of “diamond sandpaper” is, because of the temperature sensitivity of the diamond, above all wet grinding of stone surfaces.

The combination of a short life, a limited size of the grinding particles and a high price excludes the use of traditional “diamond sandpaper” when grinding large surfaces, such as floor, ceiling or wall surfaces. The temperature sensitivity and the limited size of the grinding particles besides exclude the use on moisture-sensitive surfaces, such as wood.

There is thus a need for an improved grinding and/or polishing tool, which can be used for grinding or polishing large surfaces, such as floors, ceilings and walls, and which can be manufactured at a relatively low cost and has a long life.

### SUMMARY OF THE INVENTION

An object of the present invention is to provide a grinding and/or polishing tool, which wholly or partially eliminates the drawbacks of prior art.

A further object is to provide a more efficient method of grinding and/or polishing wooden floors.

The object is achieved by a grinding and/or polishing tool, a grinding or polishing method and a manufacturing method according to the independent claims.

Thus, a grinding and/or polishing tool is provided, comprising a thin, substantially flat substrate, which has a grinding side to which grinding particles are applied, the substrate being substantially incompressible in a direction perpendicular to the grinding side, wherein the grinding particles comprise diamond particles, and the grinding particles are fixed to the substrate by a curing plastic resin.

By the substrate being “thin” is meant that its thickness is small, that is much smaller than the length and width of the substrate.

By the substrate being “substantially incompressible in a direction perpendicular to the grinding side” is meant that, in contrast to a sponge or some other flexible pad, it cannot be compressed in a manner that is observable to the user.

Such a grinding or polishing tool is relatively cheap to manufacture and provides, thanks to the combination of plastic resin and diamond particles, a considerably longer life compared with traditional sandpapers.

The diamond particles may have an average particle size between 30 and 1100 μm. This means that the particle size can be selected to provide a tool with a desired roughness.

The substrate can be substantially homogeneous, for example selected from a group consisting of a two-dimensional woven fabric, a two-dimensional gauze fabric, a plastic sheet, a sheet of paper, a sheet of cardboard, a kraft paper, and a fibre-reinforced composite board.

Alternatively, the substrate can be perforated, that is have the form of a network, a lattice or an apertured plate.

The side opposite the grinding side can be provided with mounting means, preferably Velcro means or a binder.

The substrate may have a thickness between 0.3 and 3 mm, preferably between 0.5 and 2 mm.

According to a second aspect, a grinding and/or polishing method is provided, in which a grinding or polishing tool as defined above is used.

The method may comprise grinding or polishing a surface of stone, concrete, marble or terrazzo.

Alternatively, the method may comprise grinding or polishing a surface of wood.

In one embodiment, grinding or polishing occurs substantially without supply of liquid. Such dry grinding or polishing is a requirement to allow treatment of a surface which would be damaged if subjected to wet grinding.

For example, the surface may be a floor, wall or ceiling surface.

According to a third aspect, a method is provided for manufacturing the above described grinding and/or polishing tool. The method comprises providing a thin, substantially flat substrate, which is substantially incompressible in a direction perpendicular to the grinding side, coating a first surface of the substrate with a binder comprising a plastic resin, and fixing to the binder grinding particles comprising diamond particles.

The binder can be mixed with the grinding particles before coating the substrate with the binder, and the binder and the grinding particles are applied simultaneously to the substrate.

After applying the grinding particles, the first surface can be coated with a second binder.

### BRIEF DESCRIPTION OF THE DRAWINGS

The invention will now be described in more detail with reference to the accompanying schematic drawings, which illustrate examples of embodiments.

FIG. 1a shows a grinding or polishing tool seen from the grinding side of the tool, the presence of grinding particles being illustrated only within a sector of the grinding side.

FIG. 1b is a cross-section of the grinding or polishing tool shown in FIG. 1.

FIG. 2 is a cross-section of an alternative embodiment of the grinding or polishing tool shown in FIG. 1.

### DESCRIPTION OF EMBODIMENTS

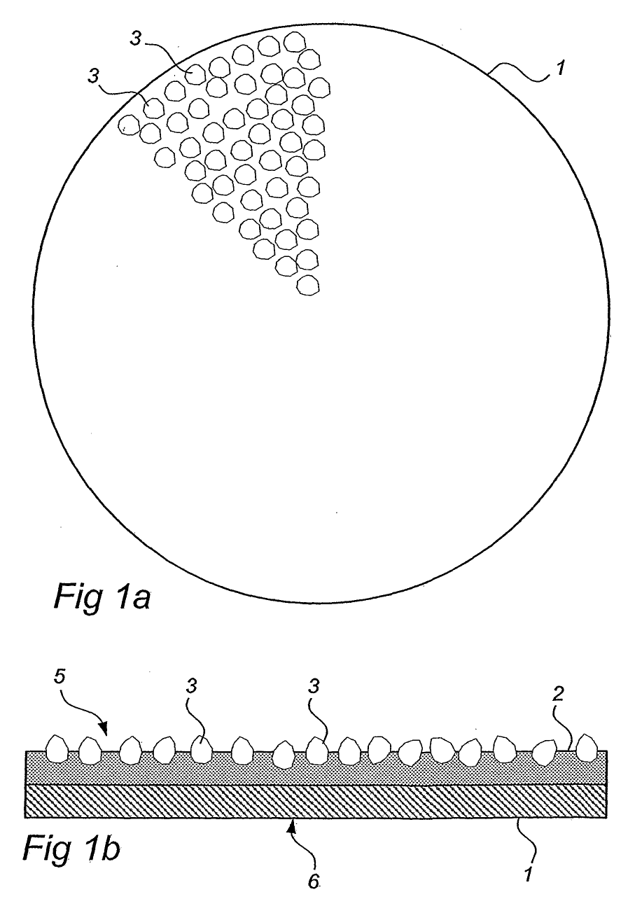

With reference to FIGS. 1a and 1b, a first embodiment of the grinding or polishing tool will now be described in more detail.

FIG. 1a shows a grinding or polishing tool where the substrate 1 is substantially circular. It will be appreciated that other shapes of the substrate are conceivable, for example rectangular, square, elliptic, triangular etc. If the substrate has edges at an angle to each other, the portions where the edges meet may be rounded.

The substrate 1 has a grinding side 5, which is provided with grinding and/or polishing particles 3. In FIG. 1a, the grinding and/or polishing particles are only shown within a sector-shaped area, but it will be appreciated that grinding and/or polishing particles 3 can be arranged over substantially the entire substrate 1 or parts thereof.

In the figures shown, the size of the grinding particles 3 are, for illustration, considerably exaggerated compared with the area and thickness of the substrate 1. Also the thickness of the substrate is exaggerated relative to its area.

The substrate is flat, homogeneous and relatively thin and may, according to alternative embodiments, comprise wood fibres (for example paper, kraft paper or cardboard). According to additional embodiments, the substrate may comprise substantially two-dimensionally woven, knitted or non-woven (gauze) fibres of polymer material (thermoplastic, for example polyamide) or natural materials (cotton, wool, flax, coconut fibres, fur/hairs of animals), metal fibres, carbon fibres, glass fibres or combinations thereof. According to further embodiments, the substrate may consist of a thin sheet of metal or polymer material, for example fibre-reinforced polymer material.

According to another variant, the substrate is flat, perforated and relatively thin. For example, the substrate may consist of one of the materials stated above, but may be formed as a loose warp or woven fabric, a network or a lattice, that is the fibres may be sparse and the materials may have a plurality of wholly or partly through-going holes. Alternatively, the substrate may be a thin sheet of metal or polymer material, which has wholly or partly through-going holes.

The thickness of the substrate may be, for example, between 0.1 and 3 mm.

The substrate may be substantially incompressible in a direction perpendicular to the grinding surface 5.

The substrate may be flexible, that is bendable, foldable or otherwise formable.

FIG. 1b shows that the grinding particles 3 are arranged in a binder 2 which in turn is applied to the substrate 1.

The adhesive binder 2 may comprise a curing plastic resin, such as phenol, melamine, acryl, urea, epoxy, polyimide etc. For instance, phenol may constitute a suitable material for applications involving lower temperature or strength requirements, while polyimide is a suitable material for applications involving higher temperature or strength requirements.

The grinding and/or polishing particles 3 comprise diamond particles. By “diamonds” is meant both natural diamonds and industrially produced diamonds, mono- or polycrystalline diamonds and coated diamond particles, such as silver-coated diamond particles.

Examples of suitable particle sizes for the diamond particles, and their equivalents on the grit scale are stated in Table 1 below.

TABLE 1
Conversion table for particle sizes

| | Micrometer |
|---|---|
| Grit | (Average) |
| 16 | 1092 |
| 20 | 940 |
| 24 | 686 |
| 30 | 559 |
| 36 | 483 |
| 46 | 356 |
| 54 | 305 |
| 60 | 254 |
| 70 | 203 |
| 80 | 165 |
| 90 | 145 |
| 100 | 122 |
| 120 | 102 |
| 150 | 89 |
| 180 | 76 |
| 220 | 63 |
| 240 | 50-53.5 |
| 280 | 40.5-44.0 |
| 320 | 32.5-36.0 |

According to one embodiment, the grinding particles may have a particle size of about 300-450 micrometer, that is about 40 grit.

According to one embodiment, the grinding particles may have a particle size of about 250 micrometer, that is about 60 grit.

According to one embodiment, the grinding particles may have a particle size of about 165 micrometer, that is about 80 grit.

According to one embodiment, the grinding particles may have a particle size of about 102 micrometer, that is about 120 grit.

According to one embodiment, the grinding particles may have a particle size of about 89 micrometer, that is about 150 grit.

According to one embodiment, the grinding particles may have a particle size of about 76 micrometer, that is about 180 grit.

According to one embodiment, the grinding particles may have a particle size of about 50-54 micrometer, that is about 240 grit.

According to one embodiment, the grinding particles may have a particle size of about 32-36 micrometer, that is about 320 grit.

Also other types of grinding/polishing particles may be added, such as aluminium oxide, stannic oxide or silicon oxide. These particles may have a particle size which is approximately the same as or smaller than the diamond particles.

It will be appreciated that the amount of binder per area unit of the substrate may be varied according to the size of the diamond particles, for instance so that a greater amount of binder is used to provide improved strength when greater diamond particles are used.

The binder can be applied to the substrate by spraying, roller-coating, printing or brushing (paint brush etc).

The grinding and/or polishing particles may be applied to the binder by, for example, being passed through a sieve or poured, followed by collection and recirculation of superfluous, non-bound particles.

Application of binder is suitably followed by curing in a furnace or the like.

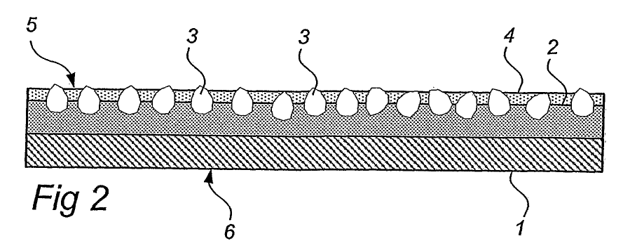

According to a first alternative embodiment, which is shown in FIG. 2, a further layer 4 of binder is applied to the substrate after providing it with grinding and/or polishing particles. This binder may be of the same type as the first adhesive binder, or of a different type.

According to a second alternative embodiment, the binder and the grinding and/or polishing particles may be mixed with each other before being applied to the substrate, after which the mixture of binder and grinding and/or polishing particles is applied simultaneously to the substrate, according to one of the methods described above.

The above described grinding and/or polishing tool is particularly suitable as replacement for conventional sandpaper for grinding and/or polishing building surfaces, such as floors, ceilings, walls or bench tops. For instance, the tool is well suited for grinding of wooden floors, where frequently relatively large surfaces of wood and/or varnished wood are to be ground, and where irregularities, such as joints between wood blocks, may have a negative effect on the life of the conventional sandpaper.

The grinding and/or polishing tool may as a non-limiting example be fixed to driven oscillating and/or rotating grinding discs. The tool may also be used for manual grinding and/or polishing.

According to one embodiment, the tool can be fixed by being folded around an edge of the grinding disc, in which case the folded part of the tool is fixed by a clamp.

According to another embodiment, the grinding tool can be fastened by means of a Velcro piece applied to the rear side 6 thereof, which piece sticks to a corresponding Velcro piece arranged on the grinding disc.

According to a third embodiment, the tool can be fastened to the grinding disc by an adhesive agent arranged on the rear side of the tool.

1. A grinding and/or polishing tool, comprising a thin, substantially flat substrate, which has a grinding side to which grinding particles are applied, the substrate being substantially incompressible in a direction perpendicular to the grinding side, the grinding particles comprise diamond particles, and the grinding particles are fixed to the substrate by a curing plastic resin, characterised in that the substrate is perforated.

2. A grinding or polishing tool as claimed in claim 1, wherein the diamond particles have an average particle size between 30 and 1100 μm.

3. A grinding or polishing tool as claimed in claim 1, wherein the substrate has the form of a network or lattice.

4. A grinding or polishing tool as claimed in, claim 1, wherein the side opposite the grinding side is provided with mounting means, preferably Velcro means or adhesive binder.

5. A grinding or polishing tool as claimed in claim 1, wherein the substrate has a thickness between 0.3 and 3 mm, preferably between 0.5 and 2 mm.

6. A grinding and/or polishing method, characterised in that a grinding or polishing tool as claimed in claim 1 is used.

7. A method as claimed in claim 6, wherein a surface of stone, concrete, marble or terrazzo is ground or polished.

8. A method as claimed in claim 6, wherein a surface of wood is ground or polished.

9. A method as claimed in claim 6, wherein said grinding or polishing occurs substantially without supply of liquid.

10. Use as claimed in claim 6, wherein the surface is a floor, wall or ceiling surface.

11. A method of manufacturing the grinding and/or polishing tool as claimed in claim 1, said method comprising providing a thin, substantially flat and perforated substrate, which is substantially incompressible in a direction perpendicular to the grinding side, coating a first surface of the substrate with a binder comprising a plastic resin, and fixing to the binder grinding particles comprising diamond particles.

12. A method as claimed in claim 11, wherein the binder is mixed with the grinding particles before coating the substrate with the binder, and wherein the binder and the grinding particles are simultaneously applied to the substrate.

13. A method as claimed in claim 11, further comprising, after applying the grinding particles, coating the first surface with a second binder.
